(19) United States
(12) Patent Application Publication
(10) Pub. No.: US 2011/0097648 A1
(43) Pub. Date: Apr. 28, 2011

(54) Control of a fluid flow in an electrochemical cell

(75) Inventor: Felix Blank, Konstanz (DE)

(73) Assignee: DaimlerChrysler AG, Stuttgart (DE)

(21) Appl. No.: 10/524,224

(22) PCT Filed: Aug. 4, 2003
(86) PCT No.: PCT/DE03/02603

§ 371 Date: Nov. 20, 2009

(30) Foreign Application Priority Data
Aug. 13, 2002 (DE) 10236998.4

(51) Int. Cl. H01M 8/04

(52) U.S. Cl. 429/514

(57) ABSTRACT

The invention relates to an electrochemical cell, especially a proton exchange membrane fuel cell (PEM fuel cell) or an electrolysis cell which displays improved efficiency as a result of improved temperature or moisture distribution and/or reactant distribution inside said cell. The invention is characterized in that in an electrochemical cell, comprising a channel structure for feeding, circulating and discharging fluids necessary for the operation of said cell, at least one element (4, 7, 8, 9-14, 22, 23, 29, 40, 48, 49) modifying the flow cross-section is integrated into at least one channel (2, 15, 26, 27, 37) of the channel structure for automatic control of at least one fluid flow (5, 24, 33, 34).

The invention relates to an electrochemical cell, in particular a proton exchange membrane fuel cell (PEM fuel cell) or an electrolysis cell, according to the precharacterizing clause of patent claim 1.

In an electrolysis cell with a cathode and an anode, electrical energy is converted into chemical energy. Electrical current is used to break down a chemical compound by an ionic discharge. When an external voltage is applied, electrons are absorbed by the ions at the cathode within a reduction process. Electrons are given off by the ions at the anode within an oxidation process. The electrolysis cell is constructed in such a way that reduction and oxidation take place separately from one another.

Fuel cells are galvanic elements with a positive terminal and a negative terminal, or with a cathode and an anode, which convert chemical energy into electrical energy. Electrodes are used for this purpose, interacting with an electrolyte and preferably a catalyst. A reduction takes place at the positive terminal, resulting in an electron deficiency. An oxidation takes place at the negative terminal, resulting in an electron excess. The electrochemical processes take place in the fuel cell as soon as an external circuit is connected.

A typical construction of a fuel cell is shown in DE 100 47 248 A1. The fuel cell comprises a cathode electrode, an anode electrode and a matrix, which together form a membrane electrode assembly (MEA). The cathode electrode and the anode electrode respectively comprise an electrically conducting body which serves as a carrier for a catalyst material. The matrix is arranged between the cathode electrode and the anode electrode and serves as a carrier for an electrolyte. A number of fuel cells are stacked on one another with separator plates interposed. The supply, circulation and, discharge of oxidants, reductants, reactants and coolants takes place by means of a system of channels, which are produced by the separator plates. For each liquid or gaseous operating material, supply collecting channels, distribution channels and discharge collecting channels are provided in the fuel cell stacks, separated from one another by sealing means. The supply collecting channels and discharge collecting channels are referred to in English-speaking regions as ports. The cells of a stack are supplied with an oxidant fluid, a reactant fluid and a coolant in parallel by means of at least one supply collecting channel. The reaction products, excess reactant and oxidant fluid and heated coolant are removed from the cells by means of at least one discharge collecting channel out of the stack. The distribution channels form a connection between the supply collecting channel and discharge collecting channel and the individual active channels of a fuel cell. The fuel cells may be connected in series to increase the voltage. The stacks are closed off by end plates and accommodated in a housing, the positive terminal and negative terminal being led to the outside to a consumer unit.

In Japanese patent application JP 60-041769 A there is a description of a fuel cell system in which a fuel cell stack is surrounded by a thermal insulator. For heat dissipation, the fuel cell stack is surrounded by a metallic body with good heat conduction. U-shaped bimetal bodies are fastened to the body. If the temperature in the fuel cell stack exceeds a predetermined temperature, the bimetal bodies are deformed and come into contact with radiator plates, so that a heat transfer takes place from the heat-conducting metallic body of the fuel cell stack via the bimetal bodies to the radiator plates. The arrangement is voluminous and the heat dissipation by means of a mechanical contact is less than satisfactory.

In the case of the liquid fuel cell system shown in Japanese patent application JP 61-058173 A, a fuel cell stack is flowed around by cooling air of a fan. The cooling air flow can be controlled by means of fins which can be pivoted by a coupling rod in the cooling air path. The coupling rod is actuated by a bimetal element, which is in thermal contact with anolyte. If there are changes in the temperature of the anolyte, the bimetal element is deformed, so that the fins open the cooling air path more or less. The cooling system is arranged on the outside of a fuel cell stack and thereby increases the overall size of a fuel cell system. The cooling system is unable to compensate for temperature inhomogeneities within a fuel cell stack. Only the overall cell temperature is controlled in each case.

Furthermore, there are known solutions which use a fluid-dynamic flow of a cooling air flow onto a fuel cell stack. In the case of the solution according to Japanese patent application JP 58-100372 A, the flow resistance of the cooling air is reduced by special shaping of a flowing-in region. In the Japanese patent application JP 58-017964 A, a uniform distribution of cooling air onto fuel cells by air baffles is described. In Japanese patent application JP 1185871 A, a special flow guide for cooling air is shown.

In the case of all these solutions, it is in each case attempted to shape the cooling air flow in such a way that the temperature of the individual cells is optimally controlled, without however adapting the cooling flow to the local requirements.

The object of the invention is to develop an electrochemical cell which has improved efficiency as a result of improved temperature or moisture distribution and/or reactant distribution within the cell.

The object is achieved by an electrochemical cell which has the features as claimed in claim 1. Advantageous configurations are provided by the subclaims.

The invention allows an open-loop or close-loop control of fluid flows in the region of an individual cell. The use of at least one element that changes the flow cross section within at least one channel allows setting of the desired temperature distribution or moisture distribution, which depends on the cooling medium and operating state of the cell.

A major advantage of the arrangement according to the invention is that each channel can be individually controlled, i.e. a variation of the pressure loss in the individual channels brings about a variation of the volumetric flows of the individual channels to and from which gas is supplied and removed jointly by means of collecting and distribution channels. A homogenization of the temperature or moisture between the channels is brought about, if a homogeneous temperature or moisture distribution is desired. If in the case of more complex fuel cell systems a specific temperature or moisture profile is desired, this can be achieved with a corresponding arrangement of the elements that change the flow cross sections.

One of the reasons for an unequal temperature distribution in a fuel cell is an inhomogeneous heat output. For example, the heat given off to the surroundings in the case of the outer cells of a fuel cell stack is greater than in the case of cells lying on the inside. In particular in the case of air cooling, a non-uniform heat output is obtained by heating up the cooling fluid. Furthermore, the reactions within a cell do not take place to the same extent everywhere, so that the sources of heat are unequally distributed. The reactions depend among other things on the local temperature, the local partial pressures and the local moisture.

With the elements that change the flow cross sections, such as bimetal strips for example, the coolant flow in each cooling channel can be controlled. This produces an optimized temperature distribution.

Furthermore, the elements that change the flow cross section can be used for open-loop or close-loop control of the local gas composition by influencing the gas flows. For example, bimetal strips may be provided in the fluid channels of one or both reaction gases. If the fluid channels are connected to one another, a gas exchange can take place between the channels. As a result, locally increased cell reactions and locally higher temperatures are achieved. Higher temperatures bring about a reduction in the cross section of the gas channels by the bimetal strips, which has the consequence that fewer reaction gases are present locally in this region of the cell and the gas flow increases in other regions. The decrease in the gas flow has the effect of reducing the cell reaction, with an intensification of the reactions in the regions where the supply is greater. A uniform reaction distribution is obtained in this way.

In a variant of the invention, the desired reaction distribution can be set by an arrangement of bimetal elements and connections between the gas channels. For this purpose, a flow field for a fluid can be divided into various regions, with a communication of fluids over different regions being possible. The fluid channels in the regions may lie parallel to one another, the elements for changing the cross sections of the channels advantageously being integrated in downstream regions.

A further possibility of locally controlling a cooling air flow and reaction gas flows is provided by the use of materials or components which change their volume or their shape in dependence on moisture. Depending on the reaction partners, in the case of a fuel cell a phase change occurs, i.e. liquid water may be produced, on the cathode side in the path of the gas flow between the inlet and the outlet of a channel. The amount of water occurring is dependent on the reaction, since the water is a reaction product. If the said materials or components are used in such a way that they reduce the channel cross sections in dependence on the moisture, the same effect as with the use of bimetal strips can be achieved in this way.

In the case of control of the local heat, bimetal strips may be used in the channels on the anode side and cathode side and in the coolant channels. In the case of moisture-dependent control, the cross-section-changing materials or components are incorporated directly in the cathode channels. If the anode fluid flow and/or the cooling fluid flow are also to be controlled moisture-dependently, the moisture in the cathode fluid flow must be recorded, in order to achieve a change in channel cross section on the anode side or cooling fluid side.

The invention is to be explained in more detail below on the basis of examplary embodiments. In the drawings:

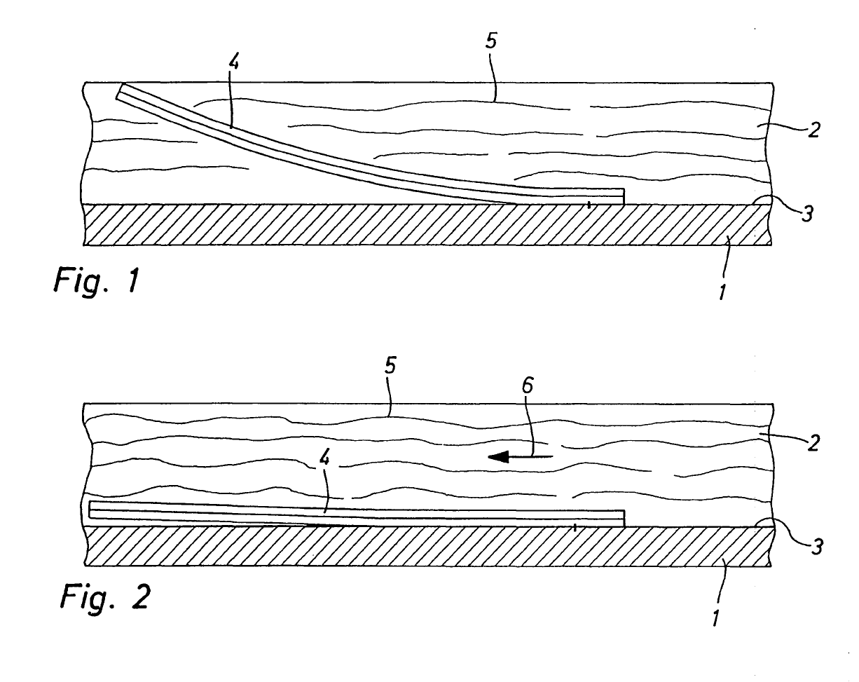

FIG. 1 shows a cooling channel of a fuel cell with a bimetal platelet arranged on the channel base, in the case of a low cooling fluid temperature,

FIG. 2 shows the cooling channel that is shown FIG. 1 in the case of a high cooling fluid temperature,

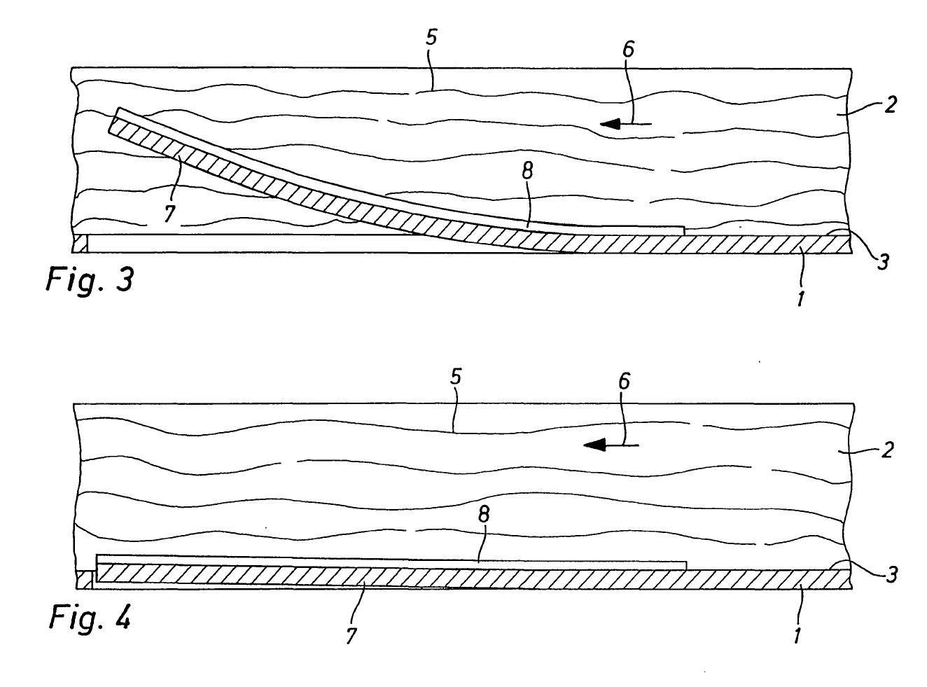

FIG. 3 shows a cooling channel of a fuel cell with a bimetal platelet integrated on the channel base, in the case of a low cooling fluid temperature,

FIG. 4 shows the cooling channel that is shown in FIG. 3, in the case of a high cooling fluid temperature,

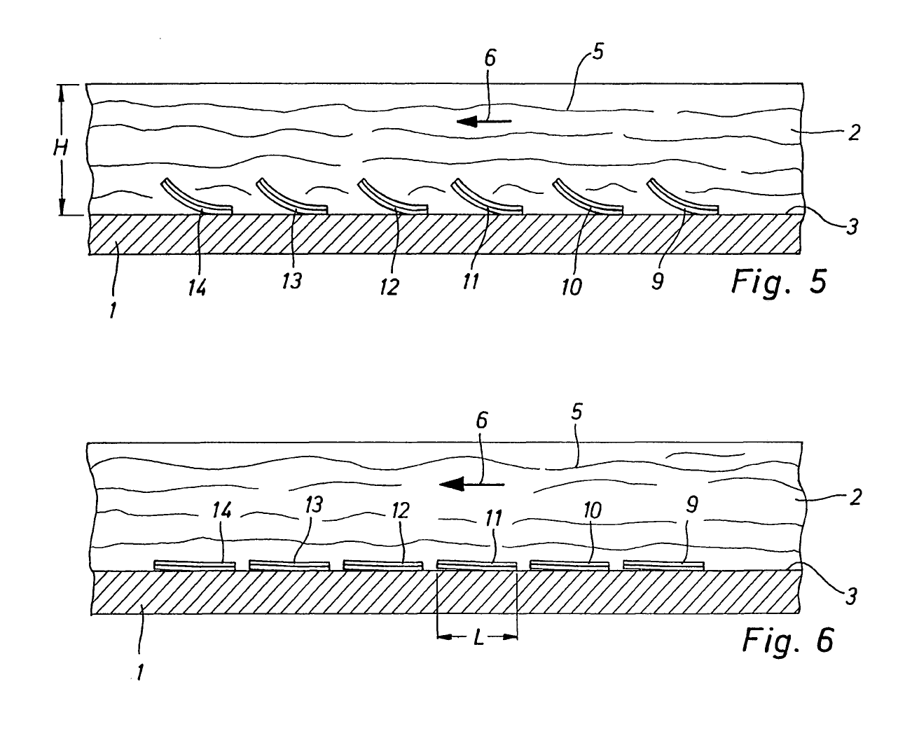

FIG. 5 shows a cooling channel of a fuel cell with a multiplicity of bimetal platelets arranged on the channel base, in the case of a high cooling fluid temperature,

FIG. 6 shows the cooling channel that is shown in FIG. 5, in the case of a low cooling fluid temperature,

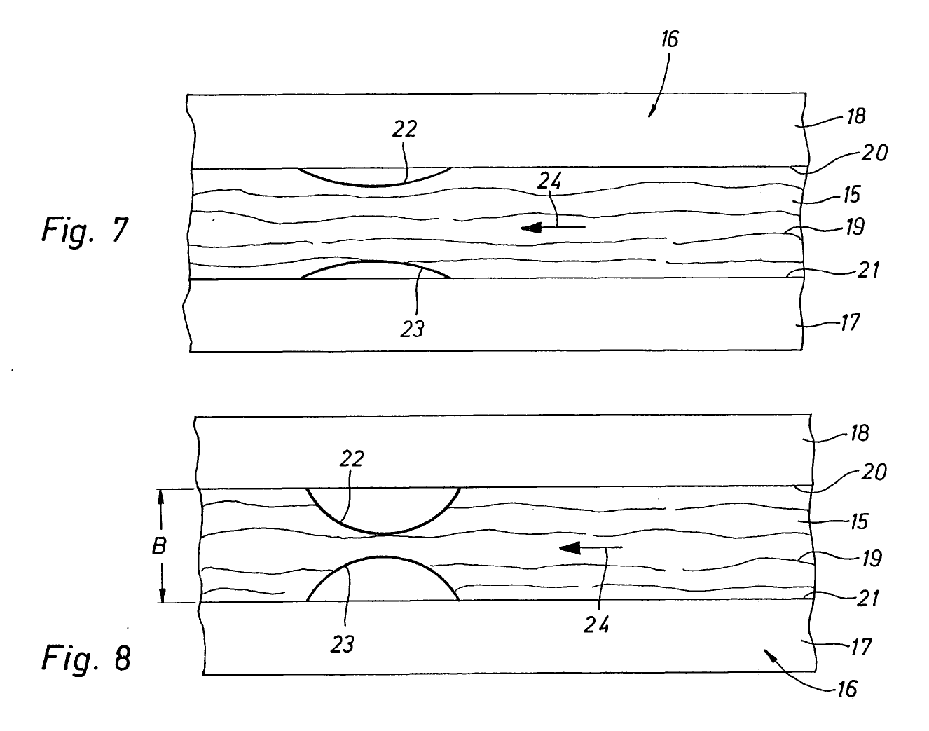

FIG. 7 shows a cathode channel of a fuel cell with moisture-dependent swelling bodies in plan view, in the case of a dry cathode fluid flow,

FIG. 8 shows the cathode channel that is shown in FIG. 7 in the case of a moist cathode fluid flow,

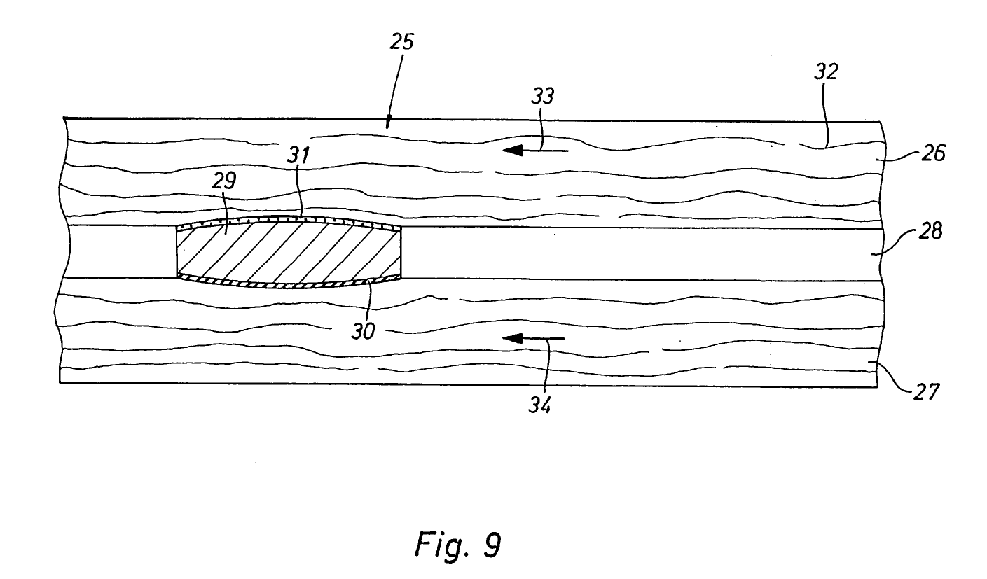

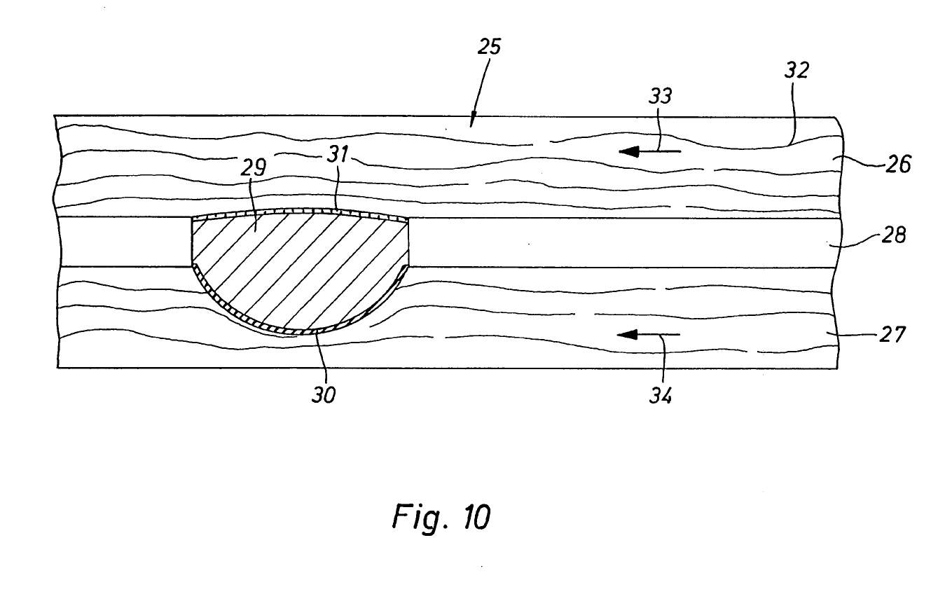

FIGS. 9 and 10 show a cathode channel of a fuel cell with moisture-dependent swelling bodies in plan view between two fluid channels, in the case of two different temperatures of a cooling fluid, and

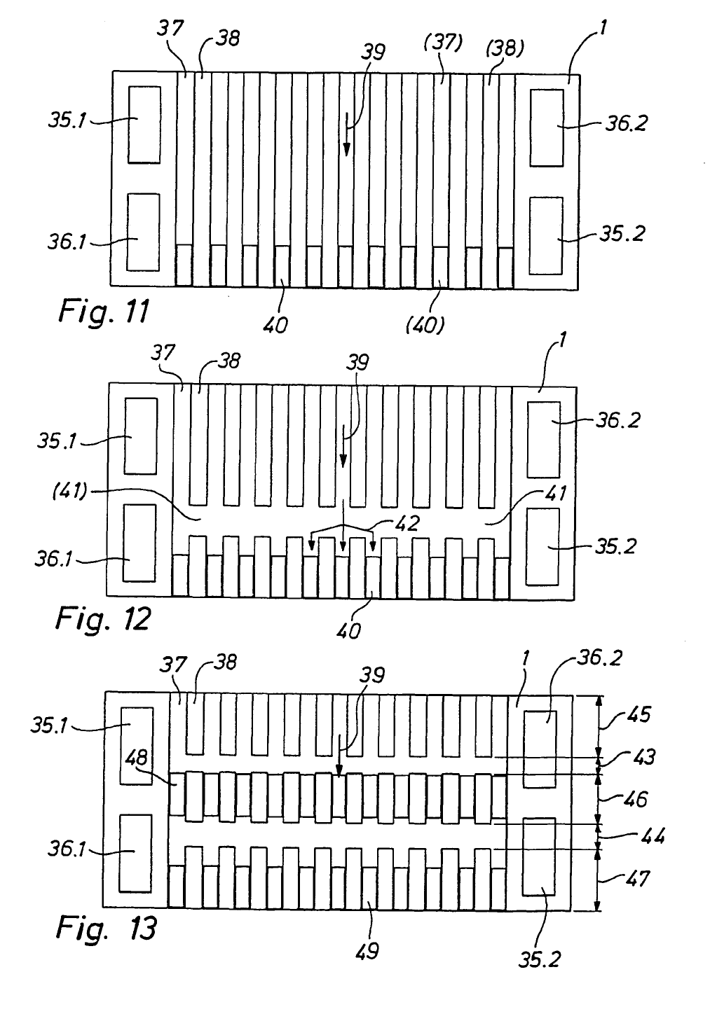

FIGS. 11-13 show various arrangements of bimetal elements in the flow field of a cooling fluid in a separator plate.

FIGS. 1 and 2 show a detail from a separator plate 1 of a fuel cell with a rectangular cooling channel 2. Fastened to the channel base 3 at one end is a likewise rectangular bimetal platelet 4. The bimetal platelet 4 is essentially of the same width as the cooling channel 2, the width extending perpendicularly in relation to the plane of the drawing. A cooling fluid 5 circulates in the cooling channel 2. If the cooling fluid 5 is at too low a temperature for the operation of the fuel cell, the bimetal platelet 4 bends up, so that the flow cross section of the cooling channel 2 is reduced. In the extreme case, the bimetal platelet 4 bends up to such an extent that, as shown in FIG. 1, it closes the cooling channel 2 completely. If the cooling fluid 5 does not flow, or only a little, the cooling fluid 5 is heated up by the process taking place in the fuel cell. As a result, the bimetal platelet 4 bends with its free end in the direction of the channel base 3 and increases the flow cross section. The cooling fluid 5 can flow in the indicated direction 6 without great resistance.

In the description which follows, the same reference numerals of elements already described are used for elements with an equivalent function.

FIGS. 3 and 4 show a detail from a separator plate 1 of a fuel cell with a rectangular cooling channel 2. On the channel base 3 there is a tongue-shaped notched portion 7, which is freely movable at one end. Over the length, the notched portion 7 is connected on the channel side to a metallic, rectangular platelet 8. The platelet 8 has a coefficient of thermal expansion that is different from the material of the notched portion 7, so that the notched portion 7 and the platelet 8 form a bimetal element. In the case of cool cooling fluid 5, the notched portion 7 together with the platelet 8 bends away from the channel base 3, as represented in FIG. 3, and reduces the flow cross section. FIG. 4 shows the state when the cooling fluid 5 is heated up. The notched portion 7 together with the platelet 8 returns into the channel base 3, so that virtually the entire flow cross section is cleared.

FIGS. 5 and 6 show a detail from a separator plate 1 of a fuel cell with a rectangular cooling channel 2. A multiplicity of rectangular bimetal platelets 9-14 are respectively fastened at one end to the channel base 3. The fastening ends of the bimetal platelets 9-14 point in the same direction. The bimetal platelets 9-14 may be essentially of the same width as the cooling channel 2 or a number of such bimetal platelets 9-14 may lie next to one another over the width of the cooling channel 2. The lengths L of the bimetal platelets 9-14 are significantly smaller in comparison with the height H of the cooling channel 2. FIG. 5 shows the state of the bimetal platelets 9-14 when the cooling fluid 5 is too warm. On account of the high temperature of the cooling fluid 5, the bimetal platelets 9-14 are raised. In this state, the raised bimetal platelets 9-14 increase the effective heat-dissipating surface area of the channel base 3. The raised bimetal platelets 9-14 increase the roughness of the walls and thereby improve the heat transfer into the material of the separator plate 1. As a result of the small length of the bimetal platelets 9-14, the flow cross section of the cooling channel 2 is reduced only insignificantly. Apart from on the channel base 3, the bimetal platelets 9-14 may of course also be arranged on the other channel walls of the cooling channel 2. In the case of a low temperature of the cooling fluid 5, the bimetal platelets 9-14 lie themselves against the channel base 3, as shown in FIG. 6, whereby the contact area with the cooling fluid 5 is reduced. The cooling fluid 5 is in this case only cooled a little via the channel base 3.

FIG. 7 shows a plan view of a cathode channel 15 of a cathode channel system of a fuel cell which is formed by a separator plate 16. The cathode channel 15 is bounded by webs 17, 18, which lie against a membrane electrode assembly. The cathode gas 19 flowing through the cathode channel 15 contacts the membrane electrode assembly and undergoes a chemical reaction there, with the formation of product water. The cathode channel 15 is of a width B and a depth which extends in a direction perpendicular to the plane of the drawing. Swelling bodies 22, 23 are arranged lying opposite one another on the side walls 20, 21 of the cathode channel 15. The swelling bodies 22, 23 consist of an elastic material, which swells in the presence of moisture. If, as shown in FIG. 7, the cathode gas 19 has a low water content, the swelling bodies 22, 23 are constricted, so that the flow cross section for the cathode gas 19 is scarcely reduced. There is a great cathode gas flow 24, which is conducive for the reaction at the membrane electrode assembly. The strong reaction produces a greater amount of product water. This brings about swelling of the swelling bodies 22, 23, as represented in FIG. 8. In this situation, the swelling bodies 22, 23 reduce the flow cross section, so that the cathode gas flow 24 is reduced. In normal operation of the fuel cell, an equilibrium is established between the flow rate and the water content of the cathode gas 19 in or between the cathode channels 15 of the cathode channel system, so that a homogenization or assimilation to a chosen profile of the temperature or moisture between the channels 15 is obtained. The swelling bodies 22, 23 may be present multiply in a cathode channel 15.

Represented in FIGS. 9 and 10 is part of a separator plate 25, formed in which are a cathode channel 26 and a cooling channel 27, which are separated from one another by a web 28 of the material of the separator plate 25. This arrangement comprising the cathode channel 26, the web 28 and the cooling channel 27 is present multiply on a separator plate 25. Incorporated in the web 28 is a swelling body 29, which has on the side of the cooling channel 27 a wall 30 of elastic, water-impermeable material and on the side of the cathode channel 26 a wall 31 of rigid, water-permeable material. The wall 30 may consist of rubber and the wall 31 may be made of metal mesh. In dependence on the water content of the cathode gas 32 in the cathode channel 26, the swelling body 29 swells to a greater or lesser extent. As shown in FIG. 9, there is less water in the cathode gas flow 33, so that the swelling body 29 is constricted and the wall 30 is drawn in. The cooling fluid flow 34 can flow virtually unhindered in the cooling channel 27, so that the cooling effect is intensified in this region of a membrane electrode assembly. If the active region of the membrane electrode assembly is cooled, the state of saturation of the cathode gas 32 is then reached, until water discharge occurs in the cathode channel 26. The water passes through the wall 31 to the swelling body 29, which swells as a result, as represented in FIG. 10. The increase in the volume of the swelling body 29 has the effect that the wall 30 expands in the direction of the cooling channel 27 and reduces its cross section. The cross-sectional reduction brings about a decrease in the cooling fluid flow 34. In normal operation of the fuel cell, an equilibrium is established between the water content of the cathode gas 32 in the cathode channels 26 and the flow rate in the cooling channels 27, so that a homogenization or assimilation to a chosen profile of the temperature or moisture between the channels 26, 27 is obtained.

Shown in FIG. 11 is a separator plate 1, on which the flow field for a cooling fluid is formed. Collecting channels 35.1, 35.2, 36.1, 36.2 are provided for the supply and discharge of anode and cathode fluid. For conducting a cooling fluid through, cooling channels 37 are impressed in the separator plate. Between the cooling channels 37 there are webs 38. Seen in the direction of flow 39 of the cooling fluid, at the outlet of the cooling channels 37 there are bimetal strips 40, which are configured in the way described with reference to FIG. 1. Since in the case of a fuel cell the heat discharge varies greatly from cooling channel 37 to cooling channel 37, dependent on the operating conditions and ambient conditions, it is of advantage if the cooling fluid flow can be controlled to the optimum temperature in each individual cooling channel 37. If air is used as the cooling fluid, the air is forced through the cooling channels 37 by a compressor. Depending on the heating up of the bimetal strips 40, the bimetal strips 40 are bent up to different heights and reduce the respective cooling channel 37 in such a way that the desired volumetric flows are obtained. That is to say that the temperatures in the individual channels 37 or cell regions are homogenized or assimilated to a chosen profile.

As a difference from FIG. 11, the flow field for a cooling fluid in FIG. 12 has apertures 41 between the cooling channels 37. This configuration can be advantageously used if the heat on a separator plate 1 is not homogeneously distributed or does not correspond to a desired profile on account of a reaction that does not proceed homogeneously or an inhomogeneous heat discharge.

In the case of the separator plate 1 shown in FIG. 12, heat is produced to a proportionately greater extent, seen in the direction of flow 39, in the last third of the cooling channels 37. Therefore, it is also only necessary here to control the volumetric flows with bimetal strips 40 which are arranged in this third. The fact that the cooling channels 37 are connected to one another via the apertures 41 means that there are cross-flows 42 of the cooling fluid between the apertures 41 when the bimetal strips 40 are in different positions.

In the case of the separator plate 1 shown in FIG. 13, channels 37 are respectively interrupted by two apertures 43, 44. Seen in the direction of flow 39, three portions 45-47 are produced for each cooling channel 37. In the two downstream portions 46, 47, a bimetal strip 48, 49 is arranged in each cooling channel 37. Consequently, the temperature on the surface of a membrane electrode assembly can be controlled independently in each portion 46, 47.

The distribution of the bimetal elements 4, 7, 8, 9-14, 40, 48, 49 and cross-section-reducing elements 22, 23, 29 for the open-loop or closed-loop control of the moisture content or the temperature of fluids is indicated in the figures and the description only by way of example. The distribution of the elements may be adapted to the respective conditions in an electrochemical cell, in particular the temperature and moisture distribution.

List of Reference Numerals Used
1 separator plate
2 cooling channel
3 channel base
4 bimetal platelet
5 cooling fluid
6 direction
7 notched portion
8 platelet
9-14 bimetal platelet
15 cathode channel
16 separator plate
17, 18 web
19 cathode gas
20, 21 side wall
22, 23 swelling body
24 cathode gas flow
25 separator plate
26 cathode channel
27 cooling channel
28 web
29 swelling body
30, 31 wall
32 cathode gas
33 cathode gas flow
34 cooling fluid flow
35.1, 35.2, 36.1, 36.2 collecting channel
37 channel
38 web
39 direction of flow
40 bimetal strip
41 aperture
42 cross-flow
43, 44 aperture
45 portion
48, 49 bimetal strip

1-17. (canceled)

18. An electrochemical cell comprising:
a) a separator plate; and
b) a channel structure for supply, circulation and discharge of fluids used in an operation of the electrochemical cell;
c) the channel structure being formed on the separator plate and including at least one fluid flow channel;
d) an element arranged within the at least one fluid flow channel for independent control of at least one fluid flow;
e) the element being arranged and configured to change a flow cross section of the at least one fluid flow channel.

19. The electrochemical cell of claim 18 wherein the element comprises at least one bimetal element arranged in the at lease one fluid flow channel.

20. The electrochemical cell of claim 19 wherein the bimetal element operates to reduce flow cross section of the channel by a thermally induced change in shape when there is a change of fluid temperature.

21. The electrochemical cell of claim 19 wherein the bimetal element comprises a separate, plate-shaped bimetal element fastened by an end to a wall of the channel.

22. The electrochemical cell of claim 19 wherein the bimetal element comprises a tongue-shaped notched portion formed on a wall of the at least one fluid flow channel and a plate-shaped element connected to the notched portion over a surface area of the notched portion.

23. The electrochemical cell of claim 19 wherein the at least one bimetal element comprises a plurality of bimetal elements fastened by an end to a wall of the at least one fluid flow channel, the bimetal elements being arranged and configured to rise upon an increase in temperature of a fluid in the at least one fluid flow channel.

24. The electrochemical cell of claim 18 wherein the element comprises at least one element arranged and configured to increase in volume upon an increase in moisture in the at least one fluid flow channel.

25. The electrochemical cell of claim 24 wherein the element is fastened to a wall of the at least one fluid flow channel.

26. The electrochemical cell of claim 25 wherein the at least one element comprises two elements arranged in a pair lying opposite one another in the fluid flow channel.

27. The electrochemical cell of claim 24 wherein the element is integrated into a wall of the fluid flow channel.

28. The electrochemical cell of claim 27 wherein the wall is arranged to separate a cathode fluid channel from a cooling fluid channel, the element comprises a water-permeable material on a side of the wall facing the cathode fluid channel and comprises an elastic, water-impermeable material on a side of the wall facing the cooling fluid channel.

29. The electrochemical cell of claim 18 wherein the channel structure is formed to include parallel fluid flow channels for a cooling fluid, each channel including at least one element.

30. The electrochemical cell of claim 18 wherein the channel structure comprises a number of regions and a plurality of fluid flow channels, each with at least one element.

31. The electrochemical cell of claim 30 wherein, for fluid communication between the channels, and over different regions, there is formed a connection between the fluid flow channels.

32. The electrochemical cell of claim 31 wherein the at least one element of each of the plurality of fluid flow channels control fluid communication between the regions.

33. The electrochemical cell of claim 30 wherein the fluid flow channels of the plurality of fluid flow channels run parallel to one another in the direction of a fluid flow in the number of regions and the connections being formed between the channels after each region, the at least one element of each channel being arranged in a downstream region for controlling fluid flows region by region.

34. The electrochemical cell of claim 33 wherein the fluid flow channels of the plurality of channels run parallel to one another in a first region, are in fluid communication with one another in a second region and run parallel in a third region, the at least one element in each channel being arranged in the third region.
